(19) United States
(12) Patent Application Publication
(10) Pub. No.: US 2020/0267350 A1
(43) Pub. Date: Aug. 20, 2020

(54) ELECTRONIC APPARATUS, CONTROL METHOD, AND RECORDING MEDIUM

(71) Applicant: SHARP KABUSHIKI KAISHA, Sakai City (JP)

(72) Inventor: EIJI KAWABATA, Sakai City (JP)

(21) Appl. No.: 16/788,108

(22) Filed: Feb. 11, 2020

(30) Foreign Application Priority Data
Feb. 15, 2019 (JP) 2019-025894

(51) Int. Cl. H04N 7/18; G06T 7/20; G06T 7/70; G10L 13/04; G05B 19/19; B25J 9/16; B25J 11/00

(52) U.S. Cl. CPC H04N 7/18; G06T 7/20; G06T 7/70; G10L 13/043; G05B 19/19; G05B 2219/35453; B25J 11/0005; G06T 2207/30196; G06T 2207/30232; G05B 2219/50391; B25J 9/1697

(57) ABSTRACT

An electronic apparatus includes at least an imaging unit taking video, at least a speech output unit outputting speech, and at least a controller. The controller performs watching by using the imaging unit and controls the speech output unit such that the speech output unit outputs the speech to notify that the watching by using the imaging unit is being performed.

### BACKGROUND

### 1. Field

The present disclosure relates to an electronic apparatus including an imaging unit, a control method, and a recording medium.

### 2. Description of the Related Art

Techniques of monitoring the inside of a home from a remote mobile terminal by using a monitoring camera are disclosed. The monitoring camera used in the techniques has an obvious purpose of keeping watching and is free from a duty to let watched persons know that they are watched.

Japanese Unexamined Patent Application No. 2004-320512 discloses such a technique.

There are growing number of cases in which an imaging unit (camera) is mounted in an electronic apparatus, such as a home appliance. It, is contemplated that a watching function and a looking-after-home function are added to such an electronic apparatus.

However, it is not clear whether the electronic apparatus is actively performing the watching function and the looking-after-home function. Users may have an uneasy feeling that they are unexpectedly watched or even aversion to the electronic apparatus.

It is desirable to provide an electronic apparatus that has an imaging unit having a watching function, causes a user to clearly recognize the status of the imaging unit in the watching function, and thus operates in a manner such that the user is less likely to have an uneasy feeling or even aversion to the electronic apparatus.

### SUMMARY

According to an aspect of the disclosure, there is provided an electronic apparatus.. The electronic apparatus includes at least an imaging unit taking video, at least a speech output unit outputting speech, and at least a controller. The controller performs watching by using the imaging unit and controls the speech output unit such that the speech output unit outputs speech to notify that the watching by using the imaging unit is being performed.

According to another aspect of the disclosure, there is provided a method controlling an electronic apparatus including at least an imaging unit taking video, at least a speech output unit outputting speech, and at least a controller. The method includes performing watching by using the imaging unit and controlling the speech output unit such that the speech output unit outputs speech to notify that the watching by using the imaging unit is being performed.

### BRIEF DESCRIPTION OF THE DRAWINGS

FIG. 1 illustrates a configuration of a robot of a first embodiment of the disclosure;

FIG. 2 is a flowchart illustrating a characteristic process of the robot of the first embodiment of the disclosure;

FIG. 3 is a flowchart illustrating the characteristic process of the robot of the first embodiment of the disclosure;

FIG. 4 is a flowchart illustrating the characteristic process of the robot of the first embodiment of the disclosure;

FIG. 5 is a flowchart illustrating the characteristic process of the robot of the first embodiment of the disclosure;

FIGS. 6A through 6C illustrate specific operations of the robot, of the first embodiment of the disclosure, wherein FIG. 6A illustrates the operation of the robot in a standard mode, FIG. 6E illustrates the operation of the robot in a moving object detection mode, and FIG. 6C illustrates the operation of the robot in a real-time mode;

FIGS. 7A and 7B illustrate specific operations of the robot of the first embodiment of the disclosure in the moving object detection mode, wherein FIG. 7A illustrates the operation of the robot when the detected moving object is non-human and FIG. 7B illustrates the operation of the robot when the detected moving object is a human; and

FIG. 8 illustrates a specific example of a table of data that is used to perform the characteristic process of the robot of the first embodiment of the disclosure.

### THE EMBODIMENTS DESCRIPTION

### First Embodiment

A first embodiment of the disclosure is described in detail below.

### Configuration of Robot

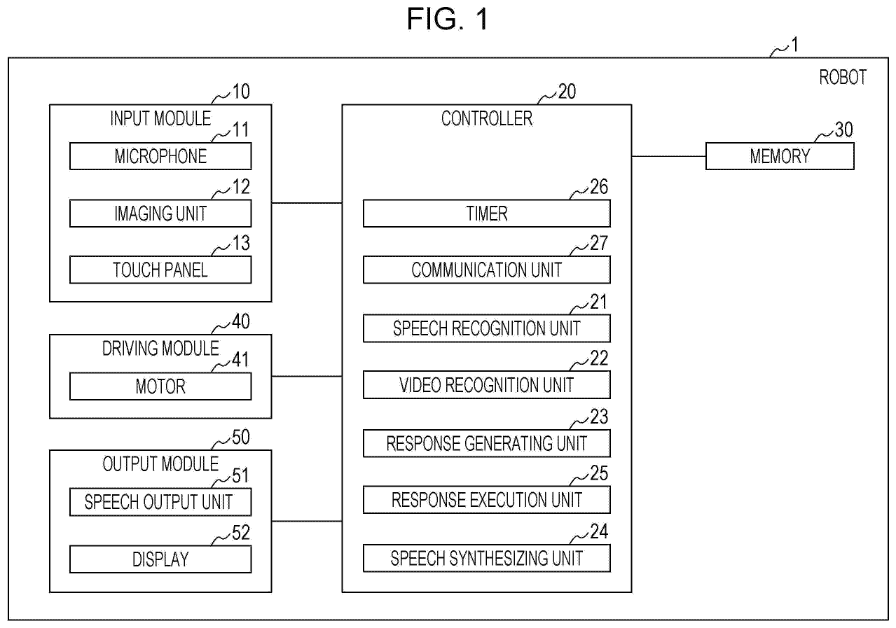

FIG. 1 is a block diagram of the configuration of a robot 1 (electronic apparatus) of the first embodiment.

The robot 1 includes an input module 10, controller 20, memory 30, driving module 40 (mechanism that changes a pose of the robot with motive power), and output module 50.

The input module 10 inputs information from an environment including a user. The input module 10 includes a microphone 11, imaging unit 12 (camera), and touch panel 13.

The controller 20 processes information and controls the operation of the robot 1. The controller 20 has function blocks including a speech recognition unit 21, video recognition unit 22, response generating unit 23, speech synthesizing unit 24, response execution unit 25, timer 26, and communication unit 27.

The memory 30 stores a variety of data. The variety of data includes speech data, music data, image data, video data, data for speech synthesis, a program causing the robot 1 to operate, and other pieces of information.

The driving module 40 physically drives the robot 1. The driving module 40 includes a motor 41 that drives elements of the robot 1 (with motive power).

The output module 50 outputs information to the environment. The output module 50 includes a speech output unit 51 and display 52. The display 52 is desirably integrated with the touch panel 13 in a unitary body.

The speech recognition unit 21 in the controller 20 performs speech recognition on speech data acquired from the microphone 11 or the like. The video recognition unit 22 performs image recognition on video data acquired from the imaging unit 12 or the like. The response generating unit 23 examines an instruction input onto the touch panel 13, results of the speech recognition, results of the image recognition, and notification by timer and determines a response that is to be performed by the robot 1.

The speech synthesizing unit 24 performs speech synthesis in accordance with speech synthesis data. The response execution unit 25 controls the driving module 40 and output module 50, thereby causing the robot 1 to give a response. The response may include posture control of the robot 1, outputting a voice from the speech output unit 51, and displaying an indication on the display 52.

The timer 26 gives a notification at predetermined time intervals if it is set in a repeat mode. The communication unit 27 controls the robot 1 in communication with outside and thus transmits and receives a variety of data. The communication unit 27 may transmit a video captured by the imaging unit 12 to a terminal of a user via a communication network. This process is executed in a real-time mode described below.

The controller 20 may be a central processing unit (CPU) that implements functions of the elements described above by executing a control program stored on the memory 30.

### Characteristic Process of Robot

In response to a user operation, the robot 1 switches between watching modes, namely, between a moving object detection mode (first operation mode) and a real-time mode (second operation mode). In the watching modes, the imaging unit 12 is active to detect the environment surrounding the robot 1. The user may perform a look-after operation and a watching operation via the robot 1. In the watching modes, the robot 1 performs the characteristic process in which the robot 1 periodically notifies the surrounding environment that the robot 1 is in the watching mode.

If a motion occurs in the video in the moving object detection mode, the robot 1 detects a corresponding moving object (a human, an animal, or a thing that moves) and stores the video. The moving object detection mode is appropriate for a relatively long time watching (look-after operation) and the robot 1. notifies the surrounding environment of the moving object detection mode at a relatively low frequency. In the following description, the time interval of notification (first time interval) includes but is not limited to 15 minutes.

When a moving object is detected in the moving object detection mode, the robot 1 notifies the surrounding environment that the moving object has been detected. The speech output intervals are modified when the video is stored with the moving object detected. A line of speech with the moving object detected is identical to a line at periodic speech. When a human is detected as the moving object, a line modified from the line at the periodic speech may be provided. Data that is to be stored may be transmitted to a user terminal via the communication network during a constant time period from the detection of the moving object.

In the real-time mode, the robot 1 may transmit a video captured. The real-time mode has a higher watching level than the moving object detection mode. In the real-time mode, the notification of the mode to the surrounding environment is performed at a higher frequency. Since the user may view the video captured by the robot 1 via a mobile communication terminal or the like, the moving object detection mode is appropriate for the look-after operation about elderly people or pets. In the following description, the notification time interval (second time interval) includes but is not limited to 30 seconds. In the real-time mode, the robot 1 performs the notification to the surrounding environment by taking a specific pose.

### Flowchart of Each Process

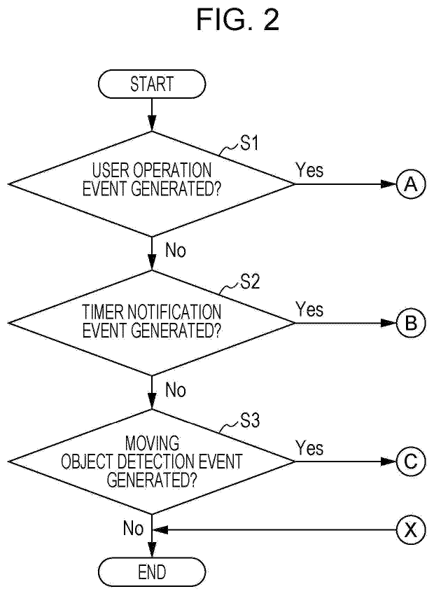

FIGS. 2 through 5 illustrate the characteristic processes of the robot 1 in operation modes. Each process is described with reference to the corresponding flowchart. Refer to a routine in FIG. 2 first.

In step S1 in the routine, the response generating unit 23 determines the occurrence of a user operation event. The user operation event occurs when the user enters an instruction on the touch panel 13 or enters an instruction via voice.

Upon receiving a user input via the touch panel 13 in the input module 10, the response generating unit 23 determines the contents of the user input. Upon receiving a voice input from the microphone 11 in the input module 10, the response generating unit 23 causes the speech recognition unit 21 to performs speech recognition and thus determines the contents of the voice input.

If the response generating unit 23 determines that the user operation input is an instruction to shift to a watching mode (yes path from step S1) , the routine proceeds to a start point A of a user operation event process; otherwise (no path from step S1), the routine proceeds to step S2

In step S2, the response generating unit 23 determines whether a timer notification event has occurred. If the response generating unit 23 determines that the timer 26 has been notifying (yes path from step S2), the routine proceeds to a start point B of a timer notification event process; otherwise (no path from step S2), the routine proceeds to step S3.

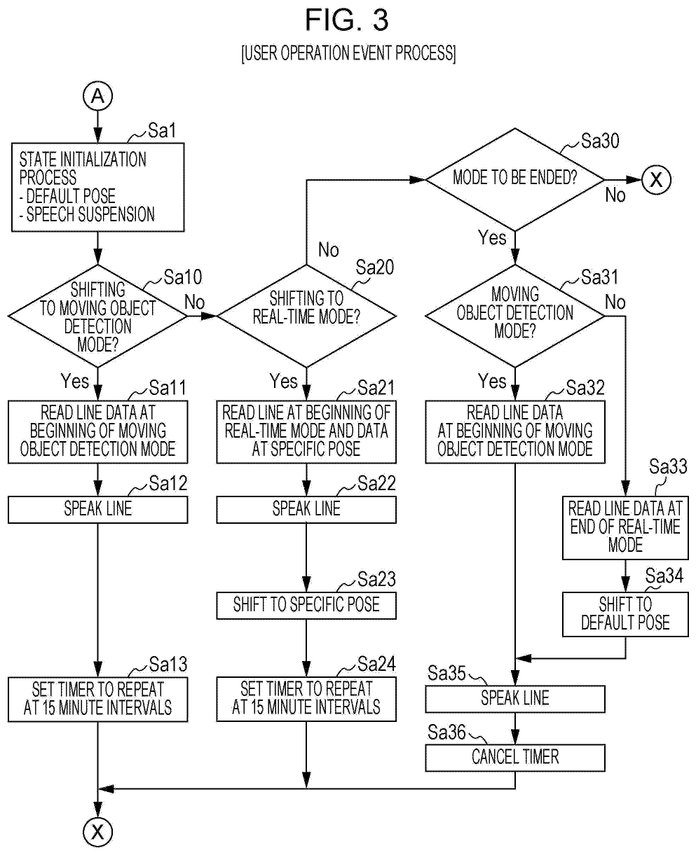

In step S3, the response generating unit 23 determines whether a moving object detection event has occurred. The response generating unit 23 causes the video recognition unit 22 to perform an image recognition process on the video from the imaging unit 12. If a moving object has been detected in the video (yes path from step S3), the routine proceeds to a start point C of a moving object detection process. If no moving object has been detected in the video (no path from step S3), the routine ends. The end point X of each process is illustrated in FIGS. 3 through 5.

### User Operation Event Process

The user operation process of the routine is described with reference to FIG. 3.

In step Sa1 following the start point A of the user operation event process, the response generating unit 23 determines the response of the robot 1 as taking a default pose as a posture and then forcibly suspending speech. The response execution unit 25 controls the driving module 40, thereby causing the robot 1 to take the default pose as the posture thereof. If the output module 50 is in the middle of outputting speech, the response execution unit 25 suspends the speech.

in step Sa10, the response generating unit 23 determines whether the user operation is an instruction to shift to the moving object detection mode. If the user operation is the instruction to shift to the moving object detection mode (yes path from step Sa10), the routine proceeds to step Sa11; otherwise (no path from step Sa10), the routine proceeds to step Sa20.

In step Sa11, the response generating unit 23 decides to shift to the moving object detection mode. The response generating unit 23 determines the response of the robot 1 as speaking a line at the start of the moving object detection mode and retrieves data for the line from the memory 30.

In step Sa12, the response execution unit 25 causes the speech synthesizing unit 24 to perform a speech synthesis process in accordance with the data for the corresponding line and causes the output module 50 to output the line from the speech output unit 51.

In step Sa13, the response generating unit 23 sets a repeat mode in the timer 26 to make a notification at 15-minute intervals. The routine then proceeds to the end point X.

In step Sa20, the response generating unit 23 determines whether the user operation is an instruction to shift the real-time mode. If the user operation is the instruction to shift to the real-time mode (yes path from step Sa20), the routine proceeds to step Sa11; otherwise (no path from step Sa20), the routine proceeds to step Sa30.

In step Sa21, the response generating unit 23 decides to shift to the real-time mode. The response generating unit 23 also determines the response of the robot 1 as speaking a line at the start of the real-time mode and retrieves data for the line from the memory 30. The response generating unit 23 determines the response of the robot 1 as taking a specific pose as the posture of the robot 1 and retrieves data for the specific pose from the memory 30.

In step Sa22, the response execution unit 25 causes the speech synthesizing unit 24 to perform a speech synthesis process in accordance with the data for the corresponding line and causes the output module 50 to speak the line via the speech output unit 51.

In step Sa23, the response execution unit 25 controls the driving module 40 in accordance with the data for the specific pose, thereby causing the robot 1 to take the specific pose.

In step Sa24, the response generating unit 23 sets the timer 26 to be in the repeat mode to give a notification at 30-second intervals. The routine proceeds to the end point X thereof.

In step Sa30, the response generating unit 23 determines whether the user operation is an instruction to end the watching mode (the moving object detection mode or the real-time mode). if the user operation is the instruction to end the watching mode (yes path from step Sa30), the routine proceeds to step Sa31; otherwise (no path from step Sa30), the routine proceeds to the end point X.

In step Sa31, the response generating unit 23 determines whether the present mode is the moving object detection mode. If the present mode is the moving object detection mode (yes path from step Sa31), the routine proceeds to step Sa32; otherwise (in no path from step Sa31), the routine proceeds to step sa33.

In step Sa32, the response generating unit 23 decides to end the moving object detection mode. The response generating unit 23 determines the response of the robot 1 as speaking the line at the end of the moving object detection mode and retrieves the data for the line from the memory 30 The routine proceeds to step Sa35.

In step Sa33, the response generating unit 23 decides to end the real-time mode. The response generating unit 23 determines the response of the robot 1 as speaking the line at the end of the real-time mode and retrieves the line at the end of the real-time mode and retrieves the data for the line from the memory 30. The response generating unit 23 also determines the response of the robot as taking the default pose as the robot posture.

In step Sa34, the response execution unit 25 controls the driving module 40, thereby causing the robot 1 to take the default pose. The routine proceeds to step Sa35.

In step Sa35, the response execution unit 25 causes the speech synthesizing unit 24 to perform the speech synthesis process in accordance with the retrieved data for the line and causes the output module 50 to speak the line via the speech output unit 51.

In step Sa36, the response generating unit 23 cancels the repeat mode on the timer 26. The routine proceeds to the end point X.

### Timer Notification Event Process

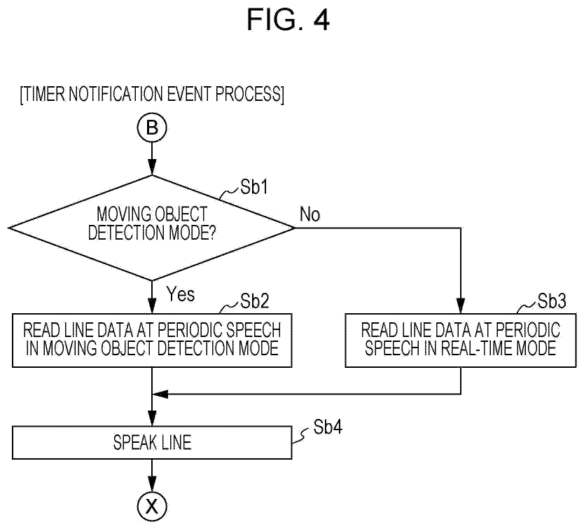

The timer notification event process is described with reference to FIG. 4.

In step Sb1, the response generating unit 23 determines whether the present mode is the moving object detection mode. If the response generating unit 23 determines that the present mode is the moving object detection mode (yes path from step Sb1), the routine proceeds to step Sb2. If the response generating unit 23 determines that the present mode is not the moving object detection mode (no path from step Sb1) , the routine proceeds to step Sb3.

In step Sb2, the response generating unit 23 determines the response of the robot 1 as speaking the line at the periodic speech in the moving object detection mode and retrieves the data for the line from the memory 30. The routine proceeds to step Sb4.

In step Sb3, the response generating unit 23 determines the response of the robot 1 as speaking the line at the periodic speech in the real-time mode and retrieves the data for the line from the memory 30. The routine proceeds to step Sb4.

In step Sb4, the response execution unit 25 causes the speech synthesizing unit 24 to perform the speech synthesis process in accordance with the retrieved data for the line and causes the output module 50 to speak the line via the speech output unit 51. The routine proceeds to the end point X.

### Moving Object Detection Event Process

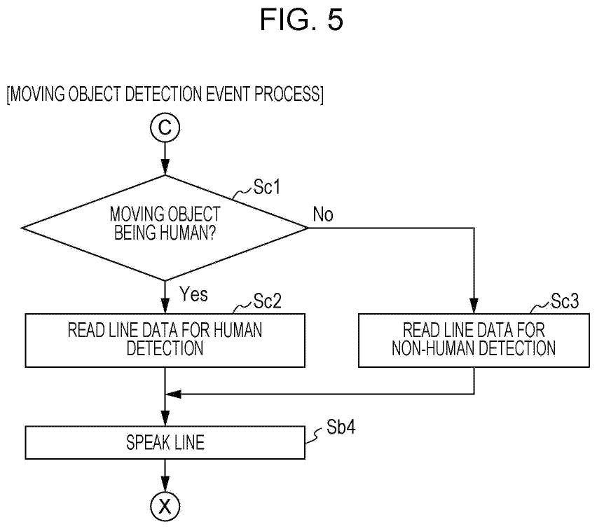

Referring to FIG. 5, the moving object detection event process of the routine is described.

In step Sc1, the response generating unit 23 determines whether the moving object detected by the video recognition unit 22 is a human. If the video recognition unit 22 has detected a human (yes path from step Sc1), the routine proceeds to step Sc2, If the video recognition unit 22 has detected a non-human object (no path from step Sc1), the routine proceeds to step Sc3.

In step Sc2, the response generating unit 23 determines the response of the robot 1 as speaking the line with the human detected and retrieves the data for the line from the memory 30. The routine proceeds to step Sc4.

In step Sc3, the response generating unit 23 determines the response of the robot 1 as speaking the line with the non-human object detected and retrieves the data for the line from the memory 30. The routine proceeds to step Sc4.

in step Sc4, the response execution unit 25 causes the speech synthesizing unit 24 to perform the speech synthesis process in accordance with the retrieved data for the line and causes the output module 50 to speak the line via the speech output unit 51. The routine proceeds to the end point X.

The controller 20 repeats the routine described with reference to FIGS. 2 through 5. The routine related to the notification of the operation mode of the robot 1 is thus performed.

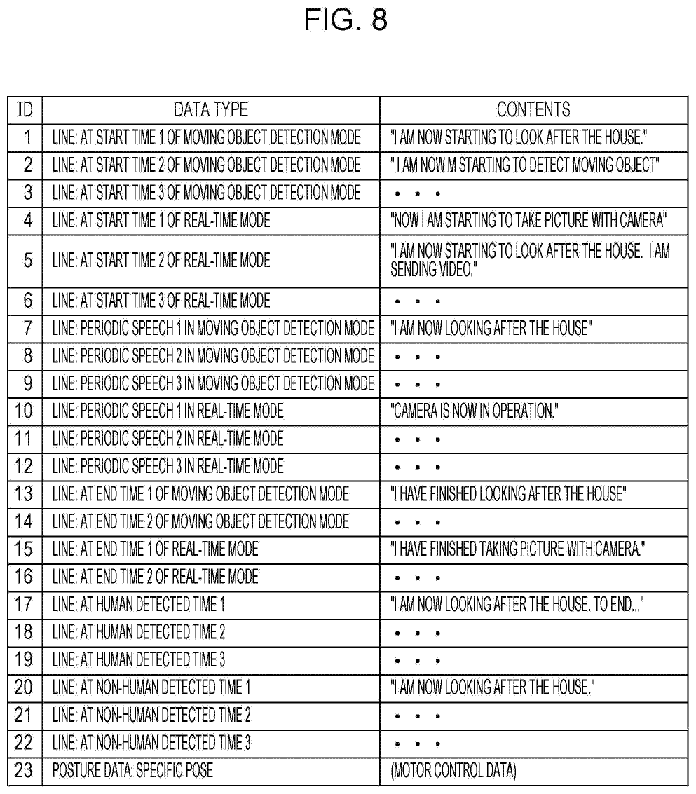

The information on the line and posture data recorded on the memory 30 and used in the routine are stored in a table form like a table as illustrated in FIG. 8. The table ties data types, data identifications (IDs), and contents such as a line with each other.

The line at a specific time, for example, at the start of the moving object detection mode, is not limited to one line. Multiple lines may be prepared as illustrated in FIG. 8. As an example, one line may be selected in a random fashion from among multiple lines in operation. As another example, one line may be selected from among multiple lines in accordance with a specific algorithm. A specific line may be selected by accounting for the character of the robot

### Specific Process Example of Robot

Process performed by the robot 1 in the routine is specifically described.

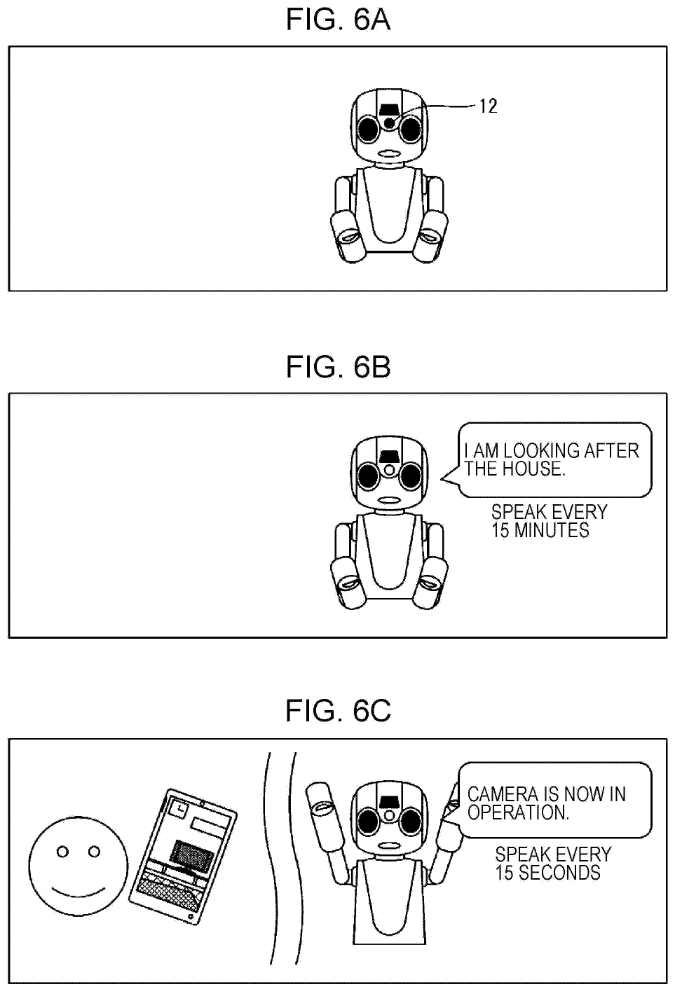

FIGS. 6A through 6C illustrate specific processes performed by the robot 1. The robot 1 includes an imaging unit 12. Referring to FIGS. 6A through 6C, operational statuses of the imaging unit 12 is labeled a blank circle and a solid circle. The blank circle indicates that the imaging unit 12 is in operation and the solid circle indicates that the imaging unit 12 is not in operation. This labeling in FIGS. 6A through 6C is illustrated for convenience only.

FIG. 6A indicates that the robot 1 is in normal operation, namely, in none of the watching modes (the moving object detection mode and the real-time mode), FIG. 6B indicates that the robot 1 is in the moving object detection mode, and FIG. 6C indicates that the robot 1 is in the real time mode.

In the moving object detection mode in FIG. 6B, the robot 1 causes the imaging unit 12 to activate to Photograph the surrounding environment. In the moving object detection mode different from the normal operation in FIG. 6A, the robot 1 speaks the line at the periodic speech in the moving object detection mode every 15 minutes. The robot 1 is not different in posture from that in the normal operation. For example, the line may be “I'm now looking after the house”.

The user may thus recognize that the robot 1 is in the moving object detection mode. The user may now be home and the robot 1 is free from the necessity of monitoring in user absence, but the user may forget to perform an operation to end the moving object detection mode. In such a case, the user may possibly notice the moving object detection mode. This controls the unnecessary continuation of watching or looking-after operation by the imaging unit 12.

If the user sets the moving object detection mode to look after elderly people, the robot 1 may speak a line at periodic speech to draw attention. For example, the robot 1 may say “I don't like looking after the house alone” or “Come over here”. The robot 1 thus causes a monitored person to guide to within a monitoring area of the imaging unit 12 from outside the monitoring area or causes a monitored person to move to record a video. The effectiveness of the looking-after operation is thus increased.

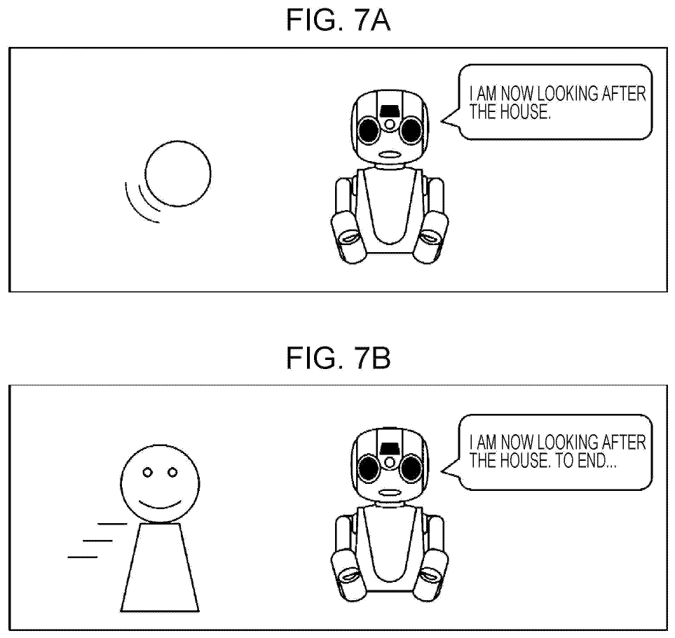

FIGS. 7A and 7B illustrate specific processes in which a moving object i detected in the moving object detection mode.

FIG. 7A illustrates specific processes in which a moving object is detected as being non-human object. The robot I then speaks a line when the non-human object is detected. For example, the line may be “I'm now looking after the house”.

Although the user is within the imaging area of the imaging unit 12, he or she may not be photographed in a state on a video appropriate for image recognition. As a result, the moving object is not recognized as a human in the video processing of the video recognition unit 22. In such a case, the robot 1 actively outputs speech and notifies persons nearby, such as a user. The user may thus easily recognize that the robot 1 is now watching with the imaging unit 12.

FIG. 7B illustrates the process in which the moving object is recognized as a human. The robot 1 then speaks a line responsive to the human detection. For example, the line may be “I'm looking after the house. To end the looking-after job, say ‘looking-after job is over’”. The user thus easily understands that the robot 1 is watching with the imaging unit 12. If it is recognized that the moving object is a human, the robot 1 also notifies the user of a method to end the moving object detection mode. The user may thus end the moving object detection mode.

The notification is thus made at the timing of the detection of the moving object. The user thus easily recognizes that the robot 1 is active in detecting the moving object. Accounting for the line at the periodic speech as well, the user may effectively control the unnecessary continuation of watching by the imaging unit 12.

When the robot 1 is in the real-time mode as in FIG. 6C, the robot 1 activates the imaging unit 12 to image the surrounding environment. In the real-time mode, the video is output from the robot 1 to a mobile communication terminal of the user via the communication network. In a manner different from the standard operation in FIG. 6A, the robot 1 speaks the line at the periodic speech in the real-time mode every 30 seconds. For example, the line may be “Camera is now in operation”. The robot 1 takes a specific pose indicating that the robot 1 is in the real-time mode.

Since the periodic speech is performed at relatively narrower time intervals (relatively higher frequency), the user may quickly recognize that the robot 1 is in the real-time mode in which the video from the imaging unit 12 is viewed on a real-time basis. By taking the specific pose different from the default pose, the robot 1 makes the impression more on the user that the imaging unit 12 is in operation than when the robot 1 is in the moving object detection mode.

When the user is back home to the robot 1, the monitoring in user absence is not desired any more. The user may immediately learn that they forget to end the real-time mode if they do. This controls the unnecessary continuation of watching by the imaging unit 12.

The robot 1 speaks a predetermined line each time the watching mode (the moving object detection mode or the real-time mode) starts or ends. The user thus recognizes that the robot 1 is to start or end each watching mode.

When the user is near the robot 1, the user may recognize that the imaging unit 12 is in operation with the robot I in either the moving object detection mode or the real-time mode. The user may clearly recognize whether the imaging unit 12 in the robot 1 performs the watching operation or the looking-after operation. In accordance with the first embodiment, the arrangement may operate in a manner such that the user is less likely to have an uneasy feeling that she or he is unexpected watched via a camera (imaging unit) or even aversion to the camera.

If the user forgets to cancel the watching mode, the resource of the robot 1 is consumed. If the user attempts to cause the robot 1 to carry out another instruction, there is a possibility that the response from the robot 1 is delayed. In such a case, the user may feel stress because she or he is unable to gain an expected response at an expected timing. The robot 1 of the first embodiment may ease such a problem.

In accordance with the first embodiment, the electronic apparatus of the disclosure is a robot and more particular, a pet robot. The disclosure is not limited to the robot. The electronic apparatus may be a robot vacuum cleaner, an artificial intelligent (AI) loudspeaker, a mobile communication terminal, such as a tablet or smart phone, or any other electronic apparatus. Implementation using software

Function blocks of the robot 1 (in particular, the controller 20 and the memory 30) may be implemented by a logic circuit (hardware) formed on an integrated circuit (IC chip) or may be implemented by software.

If the function blocks are implemented by using software, a computer is employed to execute a command of a program that is software implementing each function. The computer includes at least a processor (control device) and at least a recording medium that is readable by the computer storing the program. When the processor in the computer reads the program from the recording medium and executes the read program, the purpose of the disclosure may be achieved. The processor may be a central Processing unit (CPU). The recording medium may be a non-transitory and tangible medium, such as a read-only memory, tape, disk, card, semiconductor memory, or a programmable logic circuit. A random-access memory (RAM) on which the program is expanded may be employed. The program may be supplied to the computer via any transmission medium (such as a communication network or broadcast wave) that transmits the program. An aspect of the disclosure may be implemented in the form of a digital signal that is an electronic transmission of the program and is embedded in a carrier wave.

### Conclusion

According to a first aspect of the disclosure, there is provided an electronic apparatus. The electronic apparatus includes at least an imaging unit taking video, at least a speech output unit outputting speech, and at least a controller. The controller performs watching by using the imaging unit and controls the speech output unit such that the speech output unit outputs the speech to notify that watching by using the imaging unit is being performed.

In the configuration described above, the electronic apparatus including the imaging unit having a watching function allows the user to clearly recognize whether the imaging unit is performing the watching. The electronic apparatus thus operates in a manner such that the user is less likely to have an uneasy feeling or even aversion to the watching.

According to a second aspect of the disclosure in view of the first aspect, the controller in the electronic apparatus may perform control such that the video is stored if a moving object is detected in the video while watching by using the imaging unit is being performed.

In the configuration described above, the imaging unit is appropriate for performing watching (looking-after operation) for a relatively long period of time.

According to a third aspect of the disclosure in view of the second aspect, the controller in the electronic apparatus may modify speech output intervals when the video is stored with the moving object detected.

in the configuration described above, the user may clearly recognize the watching status of the imaging unit.

According to a fourth aspect of the disclosure in view of one of the second and third aspects, if the moving object is a human, the controller may control the speech output unit such that the speech is output in a modified form.

In the configuration described above, user convenience is increased by notifying an approaching person like a user of an operation method and the electronic apparatus operates in a manner such that the user may not have an uneasy feeling or even aversion to the electronic apparatus.

According to a fifth aspect of the disclosure in view of one of the first through fourth aspects, the electronic apparatus may be a robot having a mechanism that changes a pose of the robot with motive power. When watching by using the imaging unit is performed, the controller may control the mechanism such that the robot takes a specific pose to indicate that watching by using the imaging unit is being performed.

In the configuration described above, the user may quickly recognize the watching status of the electronic apparatus. The electronic apparatus may operate in a manner such that the user is less likely to have an uneasy feeling or even aversion to the electronic apparatus.

According to a sixth aspect of the disclosure, there is provided a method controlling an electronic apparatus (the robot 1) including at least an imaging unit taking video, at least a speech output unit outputting speech, and at least a controller. The method includes performing watching by using the imaging unit and controlling the speech output unit such that the speech output unit outputs the speech to notify that watching by using the imaging unit is being performed.

In the configuration described above, the method controls the electronic apparatus including the imaging unit having the watching function. The method may clearly cause the user to recognize the watching status of the imaging unit and may thus work in a manner such that the user is less likely to have an uneasy feeling or even aversion to the electronic apparatus.

According to a seventh aspect of the disclosure in view of the sixth aspect, there is provided a non-transitory computer readable recording medium. The non-transitory computer readable recording medium stores a program causing a computer to perform the method according to the sixth aspect.

In the configuration described above, the method controls the electronic apparatus including the imaging unit having the watching function. The method may allow the user to clearly recognize the watching status of the imaging unit and may thus work in a manner such that the user is less likely to have an uneasy feeling or even aversion to the electronic apparatus,

According to an eighth aspect of the disclosure, there is provided an electronic apparatus. The electronic apparatus includes at least an imaging unit taking video, at least a speech output unit outputting speech, and at least a controller and is enabled to operate in a first operation mode (a moving object detection mode) or a second operation mode (a real-time mode). In the first operation mode, the controller performs watching by using the imaging unit and controls the speech output unit to output the speech at first time intervals to notify that the watching by using the imaging unit is being performed. If a moving object is detected in the video in the first mode, the controller controls the speech output unit to notify that the watching by using the imaging unit is being performed. In the second operation mode, the controller performs the watching by using the imaging unit and controls the speech output unit to output the speech at second time intervals, each second time interval longer than each first time interval, to notify that the watching by using the imaging unit is being performed.

In the configuration described above, the electronic apparatus including the imaging unit having a watching function allows the user to clearly recognize whether the imaging unit is performing the watching operation. The electronic apparatus thus operates in a manner such that the user is less likely to have an uneasy feeling or even aversion to the electronic apparatus.

According to a ninth aspect of the disclosure in view of the eighth aspect, the controller in the electronic apparatus may perform control the speech output unit such that the speech output unit outputs the speech when the electronic apparatus shifts to the first operation mode, when the electronic apparatus ends the first operation mode, when the electronic apparatus shifts to the second operation mode, or when the electronic apparatus ends the second operation mode.

In the configuration described above, the user is notified that the imaging unit has started or has ended the watching operation and the user clearly recognizes the watching status of the imaging unit.

According to a tenth aspect of the disclosure in view cf one of the eighth and ninth aspects, if the moving object is a human, the controller may control the speech output unit such that the speech output unit outputs the speech about an operation method to end the first operation mode.

In the configuration described above, the user may easily end the watching operation of the imaging unit. This increases operational convenience and the electronic apparatus may thus operate in a manner such that the user is less likely to have an uneasy feeling or even aversion to the electronic apparatus.

According to an eleventh aspect of the disclosure in view of one of the eighth to tenth aspects, the electronic apparatus may be a robot having a mechanism that changes a pose of the robot with motive power. In the second operation mode, the controller may control the mechanism such that the robot takes a specific pose indicating the second operation mode.

In the configuration described above, the user may quickly recognize that the electronic apparatus is in the second operation mode that is a higher watch level. The electronic apparatus may thus operate in a manner such that the user is less likely to have an uneasy feeling or even aversion to the electronic apparatus.

According to a twelfth aspect of the disclosure, there is provided a method controlling an electronic apparatus (the robot 1) including at least an imaging unit taking video, and at least a speech output unit outputting speech and being enabled to operate in a first operation mode (a moving object detection mode) or a second operation mode (a real-time mode). The method in the first operation mode includes performing watching using the imaging unit and controlling the speech output unit to output the speech at first time intervals to notify that the watching by using the imaging unit is being performed. The method in the first mode further includes controlling, if a moving object is detected in the video, the speech output unit to notify that the watching by using the imaging unit is being performed. The method in the second operation mode includes Performing the watching by using the imaging unit and controlling the speech output unit to output the speech at second time intervals, each second time interval longer than each first time interval, to notify that the watching by using the imaging unit is being performed.

In the configuration described above, the method controls the electronic apparatus including the imaging unit having the watching function. The method may allow the user to clearly recognize the watching status of the imaging unit and may thus work in a manner such that the user is less likely to have an uneasy feeling or even aversion to the electronic apparatus.

According to a thirteenth aspect of the disclosure, there is provided a non-transitory computer readable recording medium. The non-transitory computer readable recording medium stores a program causing a computer to perform the method according to the twelfth aspect.

In the configuration described above, the method controls the electronic apparatus including the imaging unit having the watching function. The method may allow the user to clearly recognize the watching status of the imaging unit and may thus work in a manner such that the user is less likely to have an uneasy feeling or even aversion to the electronic apparatus.

The present disclosure contains subject matter related to that disclosed in Japanese Priority Patent Application JP 2019-025894 filed in the Japan Patent Office on Feb. 15, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus comprising at least an imaging unit taking video, at least a speech output unit outputting speech, and at least a controller,
wherein the controller performs watching by using the imaging unit and controls the speech output unit such that the speech output unit outputs the speech to notify that the watching by using the imaging unit is being performed.

2. The electronic apparatus according to claim 1, wherein the controller performs control such that the video is stored if a moving object is detected in the video while the watching by using the imaging unit is being performed.

3. The electronic apparatus according to claim 2, wherein the controller modifies speech output intervals if the video is stored with the moving object detected.

4. The electronic apparatus according to claim 2, wherein if the moving object is a human, the controller controls the speech output unit such that the speech is output in a modified form.

5. The electronic apparatus according to claim 1, wherein the electronic apparatus is a robot having a mechanism that changes a pose of the robot with motive power,
wherein when the watching by using the imaging unit is performed, the controller controls the mechanism such that the robot takes a specific pose to indicate that the watching by using the imaging unit is being performed.

6. A method controlling an electronic apparatus including at least an imaging unit taking video, at least a speech output unit outputting speech, and at least a controller, the method comprising:
performing watching by using the imaging unit and controlling the speech output unit such that the speech output unit outputs the speech to notify that the watching by using the imaging unit is being performed.

7. A non-transitory computer readable recording medium storing a program causing a computer to perform the method according to claim 6.
